(19) United States
(12) Patent Application Publication
(10) Pub. No.: US 2019/0317824 A1
(43) Pub. Date: Oct. 17, 2019

(54) DEPLOYMENT OF SERVICES ACROSS CLUSTERS OF NODES

(71) Applicant: Microsoft Technology Licensing, LLC, Redmond, WA (US)

(72) Inventors: Ajay MANI, Redmond, WA (US); David A. Dion, Redmond, WA (US); Marcus F. Fontoura, Redmond, WA (US); Prajakta S. Patil, Redmond, WA (US); Saad Syed, Redmond, WA (US); Shailesh P. Joshi, Redmond, WA (US); Sushant P. Rewaskar, Redmond, WA (US); Vipins Gopinadhan, Redmond, WA (US); James Ernest Johnson, Redmond, WA (US)

(73) Assignee: Microsoft Technology Licensing, LLC, Redmond, WA (US)

(21) Appl. No.: 15/950,821

(22) Filed: Apr. 11, 2018

(51) Int. Cl. G06F 9/50; G06F 9/455

(52) U.S. Cl. CPC G06F 9/5077; G06F 2009/4557; G06F 9/45558; G06F 9/5005

(57) ABSTRACT

According to examples, a system may include a plurality of clusters of nodes and a plurality of container manager hardware processors, in which each of the container manager hardware processors may manage the nodes in a respective cluster of nodes. The system may also include at least one service manager hardware processor to manage deployment of customer services across multiple clusters of the plurality of clusters of nodes through the plurality of container manager hardware processors.

### BACKGROUND

Virtualization allows for multiplexing of host resources, such as machines, between different virtual machines. Particularly, under virtualization, the host resources allocate a certain amount of resources to each of the virtual machines. Each virtual machine may then use the allocated resources to execute computing or other jobs, such as applications, services, operating systems, or the like. Within public cloud deployments, the machines that host the virtual machines may be divided into multiple clusters, in which an independent central fabric controller manages the machines in each of the clusters. Dividing the machines into clusters may provide for implementation of fault tolerance and management operations.

### BRIEF DESCRIPTION OF DRAWINGS

Features of the present disclosure are illustrated by way of example and not limited in the following figure(s), in which like numerals indicate like elements, in which:

FIG. 1 depicts a block diagram of a system for managing deployment of customer services across multiple clusters of nodes in accordance with an embodiment of the present disclosure;

FIG. 2 depicts a block diagram of a service manager that may manage deployment of customer services across multiple clusters in accordance with an embodiment of the present disclosure;

FIG. 3 depicts a block diagram of a service manager that may manage deployment of tenant services across multiple clusters in accordance with another embodiment of the present disclosure;

FIG. 4 depicts a block diagram of a service manager that may manage deployment of customer services across multiple clusters of a plurality of clusters of nodes through a plurality of container managers in accordance with a further embodiment of the present invention; and

FIGS. 5 and 6, respectively, depict flow diagrams of methods for managing deployment of customer services across multiple clusters of nodes in accordance with embodiments of the present disclosure.

### DETAILED DESCRIPTION

For simplicity and illustrative purposes, the principles of the present disclosure are described by referring mainly to embodiments and examples thereof. In the following description, numerous specific details are set forth in order to provide an understanding of the embodiments and examples. It will be apparent, however, to one of ordinary skill in the art, that the embodiments and examples may be practiced without limitation to these specific details. In some instances, well known methods and/or structures have not been described in detail so as not to unnecessarily obscure the description of the embodiments and examples. Furthermore, the embodiments and examples may be used together in various combinations.

Throughout the present disclosure, the terms “a” and “an” are intended to denote at least one of a particular element. As used herein, the term “includes” means includes but not limited to, the term “including” means including but not limited to. The term “based on” means based at least in part on.

Nodes in a data center may be divided into multiple logical units, e.g., clusters, in which each of the clusters may include any number of nodes. For instance, each of the clusters may include anywhere from around 100 nodes and around 1000 nodes, or more. The clusters may include the same or different numbers of nodes with respect to each other. The clusters may also be defined based on customer demand, build out, types of tenants, types of services to be deployed, or the like. In any regard, a separate fabric controller may manage customer service deployments on the nodes within the confines of a particular cluster. In addition, each of a customer's customer services may be deployed to the nodes in one cluster for an entire lifecycle of the customer service. This may include an increase or decrease of the footprint of nodes on which the customer service (or service instances) is deployed. As such, regardless of how the customer services of the customer may change, the customer services may be deployed to the nodes in a single cluster.

Generally speaking, the customer services of a customer may be deployed in the same cluster for the entire lifecycles of the customer services to ensure that the customer services receive a certain level of availability, a certain level of success with service level agreement terms, etc. The customer services may also be deployed in the same cluster for fault tolerance purposes. In one regard, by dividing the nodes into clusters managed by separate and independent fabric controllers, in instances in which there is a fabric controller and its backups fail, the number of nodes that may be unavailable may be limited to those in the cluster controlled by that fabric controller.

In many instances, the fabric controller may maintain a number of the nodes in the cluster as buffer nodes such that there are a certain number of nodes onto which customer services may be deployed in the event that the customer services grow. The fabric controller may also maintain the buffer nodes in the cluster for fault tolerance purposes, e.g., such that a customer service may be moved from a failed node to one of the buffer nodes. For instance, the fabric controller may maintain about 10% and about 20% of the nodes in the cluster as buffer nodes. In instances in which certain numbers of nodes in each of the clusters are maintained as buffer nodes, a large number, e.g., around 10% and around 20% of all of the nodes in a data center may be unavailable at any given time to receive a customer service deployment.

As the efficiency corresponding to deployment of the customer services may be increased with increased numbers of nodes in a pool of available nodes, the splitting of the nodes in the clusters and the use of buffer nodes as discussed above may result in less efficient customer service deployments. That is, the efficiency may be lower than the efficiency corresponding to deployment of the customer services on a larger pool of nodes. Additionally, the buffer nodes may sit idle and may not be used, which may result in unutilized nodes.

Disclosed herein are systems, apparatuses, and methods that may improve utilization of nodes to which customer services may be deployed. As a result, for instance, customer services (e.g., the services of a particular customer) may be deployed in a manner that is more efficient than may be possible with known systems. Additionally, the systems, apparatuses, and methods disclosed herein may include features that may reduce customer service deployment failures and may thus improve fault tolerance in the deployment and hosting of the customer services. Accordingly, a technical improvement afforded by the systems, apparatuses, and methods disclosed herein may be that customer services may be deployed across a larger number of nodes, which may result in a greater utilization level of a larger number of the nodes. Additionally, the inclusion of the larger number of nodes in a pool of available nodes to which customer services may be deployed may enable the customer services to be deployed in a more efficient manner. Furthermore, the systems, apparatuses, and methods disclosed herein may improve fault tolerance by reducing or limiting the nodes and/or services that may be affected during faults.

According to examples, the systems, apparatuses and methods disclosed herein may split customer service management and the node (device) management to separate managers. For instance, a service manager may manage allocation and deployment of customer services and separate container managers may manage the nodes to deploy the customer services on the nodes. Thus, the container managers may manage the nodes based on instructions received from the service manager. In addition, as the service manager may instruct multiple ones of the container managers, the service manager may deploy customer services to nodes in multiple clusters. In one regard, therefore, the service manager may not be limited to deploying a customer's services to a single cluster. Instead, the service manager may deploy a customer's services onto nodes across multiple clusters. As a result, the service manager may have greater flexibility in deploying the customer's services.

In addition to the above-identified technical improvements, through implementation of the features of the present disclosure, sizes of customer services may not be restricted to the particular size of the cluster in which the services for that customer are deployed. In addition, when an existing cluster is decommissioned or when the customer services in the existing cluster are to be migrated, the customer services deployed on the nodes of the existing cluster may be moved to other nodes without, for instance, requiring that new nodes be installed to host the customer services during or after migration. That is, for instance, the service manager may deploy and/or migrate customer services to nodes outside of the existing cluster and thus, the service manager may have greater flexibility with respect to deployment of the customer services. Moreover, the service manager may function transparently to customers.

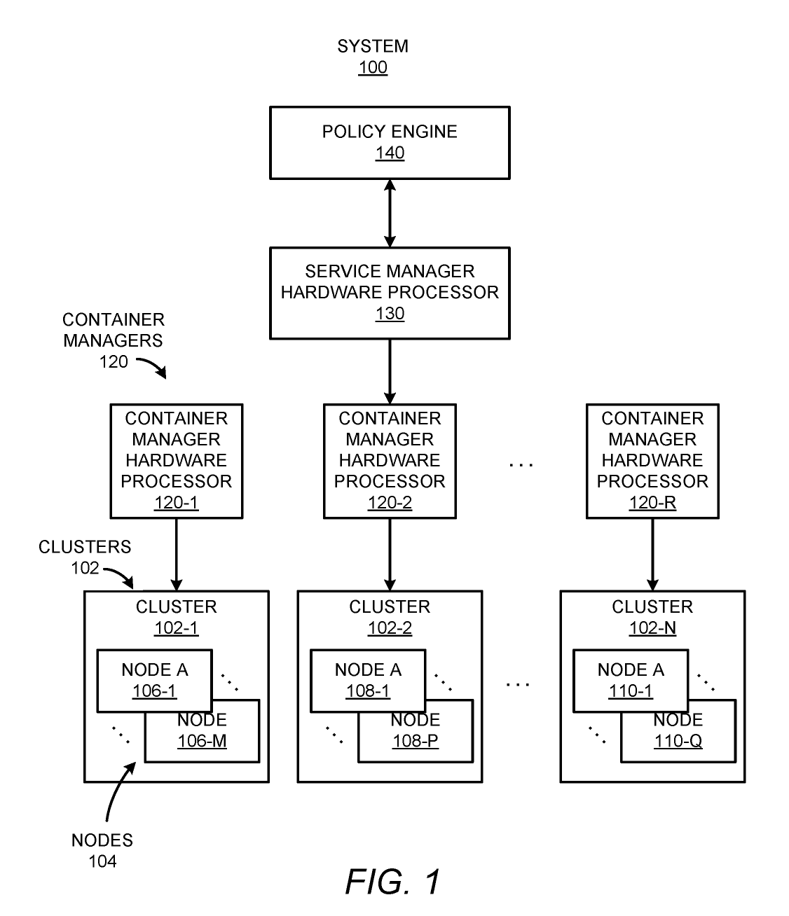

With reference first to FIG. 1, there is shown a block diagram of a system 100 for managing deployment of customer services across multiple clusters of nodes in accordance with an embodiment of the present disclosure. It should be understood that the system 100 depicted in FIG. 1 may include additional features and that some of the features described herein may be removed and/or modified without departing from the scope of the system 100.

The system 100 may include a plurality of clusters 102-1 to 102-N of nodes 104. The plurality of clusters 102-1 to 102-N are referenced herein as clusters 102 and the variable “N” may represent a value greater than one. Each of the clusters 102 may include a respective set of nodes 104 and the nodes 104 may include all of the nodes 104 in a data center or a subset of the nodes 104 in a data center. As shown, a first cluster 102-1 may include a first set of nodes 106-1 to 106-M, a second cluster 102-2 may include a second set of nodes 108-1 to 108-P, and a N cluster 102-N may include an N^{th} set of nodes 110-1 to 110-Q. The variables M, P, and Q, may each represent a value greater than one and may differ from each other, although in some examples, the variables M, P, and Z may each represent the same value.

The nodes 104 may be machines, e.g., servers, storage devices, cpus, or the like. In addition, each of the clusters 102 may be a logical unit of nodes 104 in which none of the nodes 104 may be included in multiple ones of the clusters 102. The clusters 102 may be defined based on customer demand, build out, types of customers (which are also referenced herein equivalently as tenants), types of services to be deployed, or the like. For instance, a cluster 102 may be defined to include a set of nodes 104 that were built out together. As another example, a cluster 102 may be defined to include a set of nodes 104 that are to support a particular customer.

As also shown, the system 100 may include container managers 120 that may manage an inventory of the respective nodes 104 in the clusters 120 that the container managers 120 manage. That is, each of the container managers 120 may manage the nodes 102 in a particular cluster 102-1 to 102-N. The container managers 120 may include container manager hardware processors 120-1 to 120-R, in which the variable R may represent a value greater than one. The container manager hardware processors 120-1 to 120-R may each be a semiconductor-based microprocessor, a central processing unit (CPU), an application specific integrated circuit (ASIC), a field-programmable gate array (FPGA), and/or other hardware device. One or more of the container manager hardware processors 120-1 to 102-R may also include multiple hardware processors such that, for instance, functions of a container manager hardware processor 120-1 may be distributed across multiple hardware processors.

According to examples, a first container manager hardware processor 120-1 may manage the nodes 106-1 to 106-M in the first cluster 102-1, a second container manager hardware processor 120-2 may manage the nodes 108-1 to 108-P in the second cluster 102-2, and so forth. Particularly, for instance, a container manager hardware processor 120-1 may generate and update an inventory of the nodes 106-1 to 106-M in the first cluster 102-1, e.g., a physical inventory, an identification of which virtual machines are hosted on which of the nodes 106-1 to 106-M, etc. In addition, the container manager hardware processor 120-1 may drive the nodes 106-1 to 106-M in the first cluster 102-1 to particular states based on instructions received from a service manager hardware processor 130. By way of particular example, the container manager hardware processor 120-1 may receive an instruction to deploy virtual machines on two of the nodes 106-1 and 106-2 in the first cluster 102-1 and the container manager hardware processor 120-1 may deploy the virtual machines on the nodes 106-1 and 106-2. The other container manager hardware processors 120-2 to 120-R may function similarly.

The service manager hardware processor 130 (which is also referenced equivalently herein as a service manager 130), may manage deployment of services, e.g., virtual machines, applications, software, etc., for a particular customer, across multiple clusters 102 of nodes 104. That is, the service manager hardware processor 130 may, for the same customer (or tenant), deploy the customer's services (or equivalently, service instances) on nodes 104 that are in different clusters 102. Thus, for instance, the service manager hardware processor 130 may deploy a first customer service to a first node 106-1 in a first cluster 102-1 and a second customer service to a second node 108-1 in a second cluster 102-2. In this regard, the service manager hardware processor 130 that deploys the customer services may be separate from each of the container managers 120 and may also deploy the customer services across multiple clusters 102.

According to examples, the service manager hardware processor 130 may receive requests regarding the customer services. The requests may include requests for deployment of the customer services, requests for currently deployed customer services to be updated, requests for deletion of currently deployed customer services, and/or the like. The service manager hardware processor 130 may determine expected states for a plurality of the nodes 104 based on the received requests. For instance, the service manager hardware processor 130 may determine the expected states for the nodes 104 on which the customer services are deployed to execute the received requests. In addition, the service manager hardware processor 130 may instruct at least one of the container manager hardware processors 120-1 to 120-R to drive the nodes 104 to the expected states. In one regard, the service manager hardware processor 130 may determine the expected states and the container manager hardware processor 120 may drive the nodes 104 to the expected states.

In one regard, the service manager hardware processor 130 may, for a given customer, have a larger pool of nodes 104 to which the customer's services may be deployed. As a result, for instance, the service manager hardware processor 130 may deploy services in an efficient manner. In addition, the service manager hardware processor 130 may handle increases in the services for the customer that may exceed the capabilities of the nodes 106-1 to 106-M in any one cluster 102-1 without, for instance, requiring that additional nodes be added to the cluster 102-1 or that the customer services deployed on the nodes 106-1 to 106-M be migrated to the nodes in a larger cluster. Moreover, if some of the nodes 106-1 to 106-M in the cluster 102-1 fail, migration of the services deployed to those failed nodes 106-1 to 106-M may not be limited to nodes in the cluster 102-1 designated as buffer nodes. Instead, the services deployed to those failed nodes 106-1 to 106-M may be migrated to other nodes outside of the cluster 102-1, which may improve fault tolerance in the deployment of the customer services.

The service manager hardware processor 130 may be or include a semiconductor-based microprocessor, a central processing unit (CPU), an application specific integrated circuit (ASIC), a field-programmable gate array (FPGA), and/or other hardware device. The service manager hardware processor 130 may also include multiple hardware processors such that, for instance, a distributed set of multiple hardware processors may perform the functions or services of the service manager hardware processor 130.

The system 100 may also include a policy engine 140, which may be a hardware processor or machine readable instructions that a hardware processor may execute. The policy engine 140 may determine whether and/or when certain actions that the service manager hardware processor 130 are to execute with respect to the customer services are permitted. For instance, the policy engine 140 may have a database of policies that the policy engine 140 may use in determining whether to allow the actions. By way of example, the service manager hardware processor 130 may receive a request to execute an action (e.g., determine an action to be taken) on a customer service, such as taking down a service instance, rebooting a node, upgrading an operating system of a node, migrating a service instance, upgrading a service, upgrading a service instance, or the like. In addition, the service manager hardware processor 130 may submit a request for approval of the determined action to the policy engine 140. The policy engine 140 may determine whether the determined action may violate a policy and if so, the policy engine 140 may deny the request. For instance, the policy engine 140 may determine that the determined action may result in a number of services dropping below an allowed number and may thus deny the request. If the policy engine 140 determines that the determined action does not violate a policy, the policy engine 140 may approve the request. In addition, the policy engine 140 may send the result of the determination back to the service manager hardware processor 130.

In response to receipt of an approval from the policy engine 140 to perform the determined action, the service manager hardware processor 130 may output an instruction to the container manager hardware processor 120-1 to 120-R that manages the node 104 on which the customer service is deployed to perform the determined action. However, in response to receipt of a denial from the policy engine 140, the service manager hardware processor 130 may drop or deny the determined action. For instance, the service manager hardware processor 130 may output a response to a customer to inform the customer that the request for execution of the action is denied.

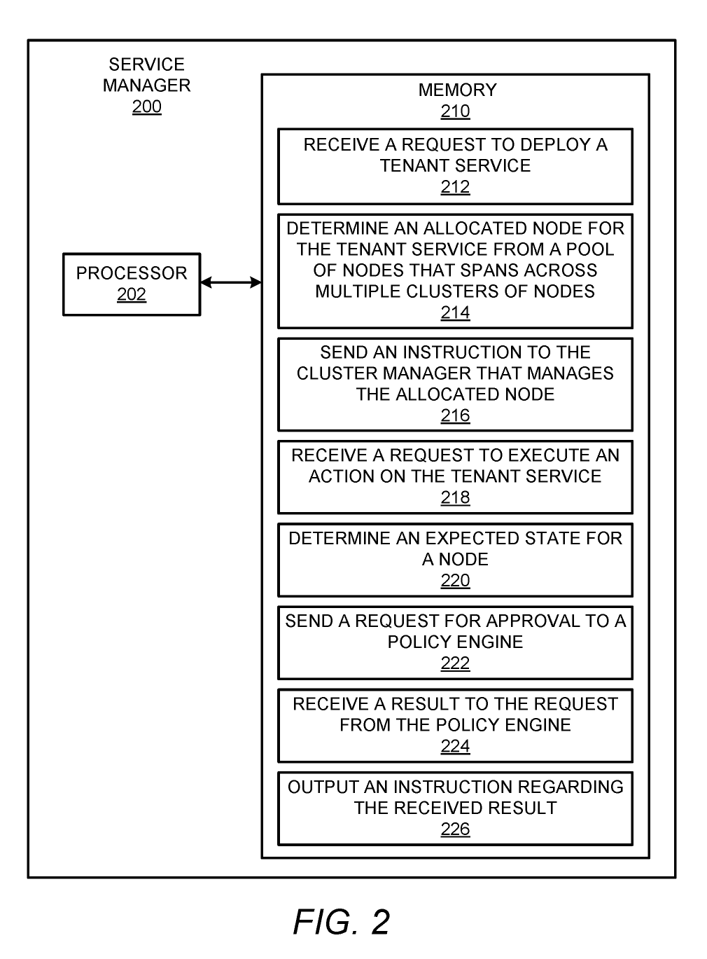

With reference now to FIG. 2, there is shown a block diagram of a service manager 200 that may manage deployment of customer services across multiple clusters of a plurality of clusters of nodes through a plurality of container managers in accordance with an embodiment of the present invention. It should be understood that the service manager 200 depicted in FIG. 2 may include additional features and that some of the features described herein may be removed and/or modified without departing from the scope of the service manager 200.

Generally speaking the service manager 200 may be equivalent to the service manager 130 depicted in FIG. 1. The description of the service manager 200 is thus made with reference to the features depicted in FIG. 1. In addition, although the service manager 200 is depicted in FIG. 2 as a single apparatus, it should be understood that components of the service manager 200 may be distributed across multiple apparatuses, e.g., servers, nodes, machines, etc.

The service manager 200 may include a processor 202, which may be a semiconductor-based microprocessor, a central processing unit (CPU), an application specific integrated circuit (ASIC), a field-programmable gate array (FPGA), and/or other hardware device. Although the service manager 200 is depicted as having a single processor 202, it should be understood that the service manager 200 may include additional processors and/or cores without departing from a scope of the service manager 200. In this regard, references to a single processor 202 as well as to a single memory 210 may be understood to additionally or alternatively pertain to multiple processors 202 and multiple memories 210.

The service manager 200 may also include a memory 210, which may be, for example, Random Access memory (RAM), an Electrically Erasable Programmable Read-Only Memory (EEPROM), a storage device, an optical disc, or the like. The memory 210, which may also be referred to as a computer readable storage medium, may be a non-transitory machine-readable storage medium, where the term “non-transitory” does not encompass transitory propagating signals. In any regard, the memory 210 may have stored thereon machine readable instructions 212-226.

The processor 202 may fetch, decode, and execute the instructions 212 to receive a request to deploy a tenant service (which is also equivalently referenced herein as a customer service). The tenant service may be in addition to previous tenant services that the service manager 200 may have deployed. In this regard, the tenant service may be an additional service for a particular tenant or customer.

The processor 202 may fetch, decode, and execute the instructions 214 to determine an allocated node 104 for the tenant service from a pool of nodes 104 that spans across multiple clusters 102 of nodes, in which a separate container manager 120 manages the nodes 104 in a respective cluster 102 of nodes. As discussed in further detail herein, the service manager 200 may include an allocator that may determine the node allocation for tenant service from the pool of available nodes 104.

The processor 202 may fetch, decode, and execute the instructions 216 to send an instruction to the container manager 102-1 that manages the allocated node 104 to drive the allocated node 104 to host the tenant service. Based on or in response to receipt of the instruction from the service manager 200, the container manager 102-1 may drive the allocated node 104 to host the tenant service. In other words, the container manager 102-1 may cause the allocated node 104 to execute or host the tenant service.

The processor 202 may fetch, decode, and execute the instructions 218 to receive a request to execute an action on the tenant service. For instance, following deployment of the tenant service to a node 104, the processor 202 may receive a request from the tenant or an administrator to execute an action on the tenant service. The request may include a request to take down a service instance, reboot a node, upgrade an operating system of the node 104, migrate a service instance, upgrade a service instance, or the like.

The processor 202 may fetch, decode, and execute the instructions 220 to determine an expected state for a node 104. The expected state for the node 104 may be state of the node 104 to execute the requested action. In addition, the processor 202 may fetch, decode, and execute the instructions 222 to send a request for approval to execute the action to the policy engine 140. As discussed herein, the policy engine 140 may determine whether execution of the action is approved or denied. The processor 202 may fetch, decode, and execute the instructions 224 to receive a result to the request from the policy engine 140. In addition, the processor 202 may fetch, decode, and execute the instructions 226 to output an instruction regarding the received result. For instance, based on receipt of an approval to execute the action from the policy engine, the processor 202 may instruct the container manager 120 that manages the node 104 to execute the action. However, based on receipt of a denial to execute the action from the policy, the processor 202 may deny the request to execute the action and/or may output a response to indicate that the request to execute the action was denied.

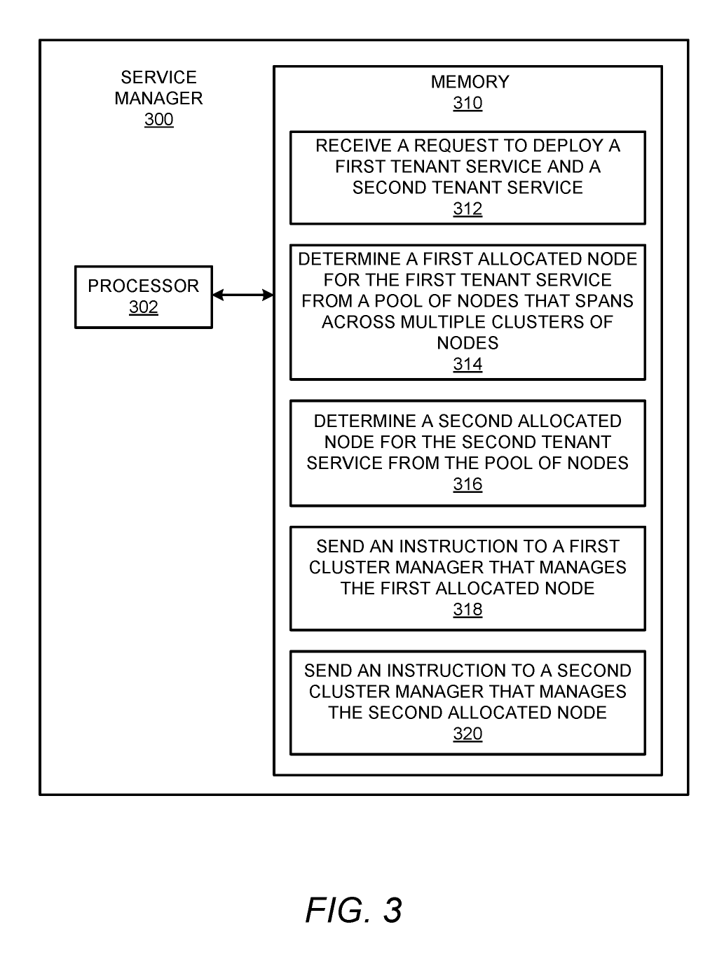

With reference now to FIG. 3, there is shown a block diagram of a service manager 300 that may manage deployment of customer services across multiple clusters of a plurality of clusters of nodes through a plurality of container managers in accordance with another embodiment of the present invention. It should be understood that the service manager 300 depicted in FIG. 3 may include additional features and that some of the features described herein may be removed and/or modified without departing from the scope of the service manager 300.

Generally speaking the service manager 300 may be equivalent to the service manager 130 depicted in FIG. 1. The description of service manager 300 is thus made with reference to the features depicted in FIG. 1. In addition, although the service manager 300 is depicted in FIG. 3 as a single apparatus, it should be understood that components of the service manager 300 may be distributed across multiple apparatuses, e.g., servers, nodes, machines, etc.

The service manager 300 may include a processor 302, which may be a semiconductor-based microprocessor, a central processing unit (CPU), an application specific integrated circuit (ASIC), a field-programmable gate array (FPGA), and/or other hardware device. Although the service manager 300 is depicted as having a single processor 302, it should be understood that the service manager 300 may include additional processors and/or cores without departing from a scope of the service manager 300. In this regard, references to a single processor 302 as well as to a single memory 310 may be understood to additionally or alternatively pertain to multiple processor 302 and multiple memories 310.

The service manager 300 may also include a memory 310, which may be, for example, Random Access memory (RAM), an Electrically Erasable Programmable Read-Only Memory (EEPROM), a storage device, an optical disc, or the like. The memory 310, which may also be referred to as a computer readable storage medium, may be a non-transitory machine-readable storage medium, where the term “non-transitory” does not encompass transitory propagating signals. In any regard, the memory 310 may have stored thereon machine readable instructions 312-320.

The processor 302 may fetch, decode, and execute the instructions 312 to receive a request to deploy a first tenant service (which is also equivalently referenced herein as a first customer service) and to deploy a second tenant service (which is also equivalently referenced herein as a second customer service). The first tenant service and the second tenant service may be services for the same tenant. In addition, the first tenant service and the second tenant service may be services that are in addition to previous tenant services that the service manager 300 may have deployed for the tenant.

The processor 302 may fetch, decode, and execute the instructions 314 to determine a first allocated node 106-1 for the first tenant service from a pool of nodes 104 that spans across multiple clusters 102 of nodes. The processor 302 may fetch, decode, and execute the instructions 316 to determine a second allocated node 108-1 for the second tenant service from the pool of nodes 104 that spans across multiple clusters 102 of nodes. Thus, for instance, the first allocated node 106-1 may be in a first cluster 102-1 and the second allocated node 108-1 may be in a second cluster 102-2. As discussed herein, a first container manager 120-1 may manage the first allocated node 106-1 and a second container manager 120-2 may manage the second allocated node 108-1. As also discussed in detail herein, the service manager 300 may include an allocator that may determine the node allocation for the tenant service from the pool of available nodes 104.

The processor 302 may fetch, decode, and execute the instructions 318 to send an instruction to the first cluster manager 120-1 that manages the first allocated node 106-1 to drive the first allocated node 106-1 to host the first tenant service. In addition, the processor 302 may fetch, decode, and execute the instructions 320 to send an instruction to the second cluster manager 120-2 that manages the second allocated node 108-1 to drive the second allocated node 108-1 to host the second tenant service.

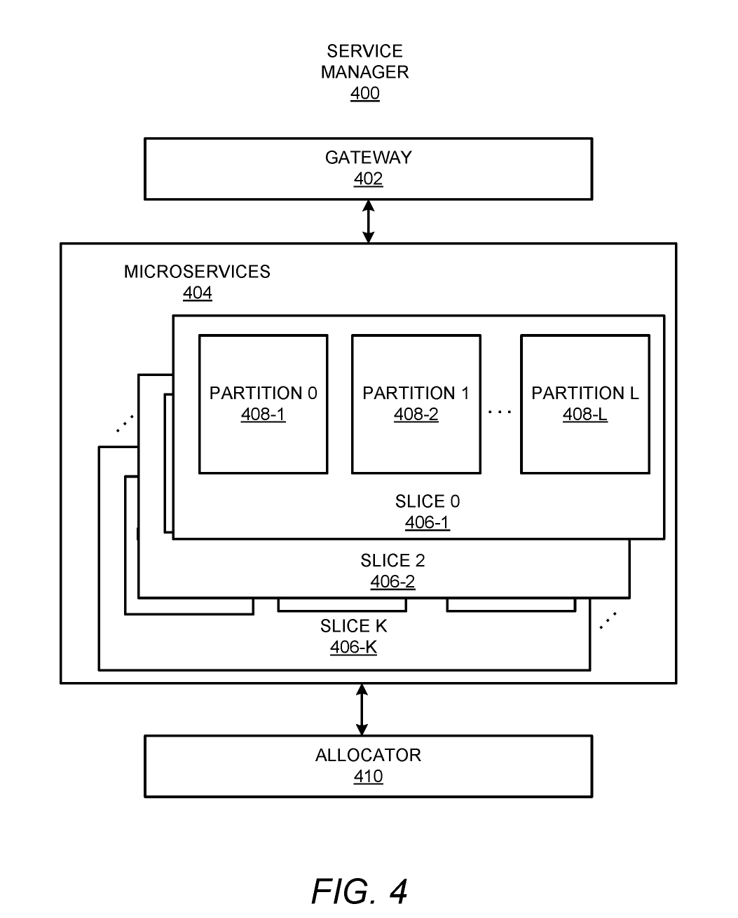

Turning now to FIG. 4, there is shown a block diagram of a service manager 400 that may manage deployment of customer services across multiple clusters 120 of a plurality of clusters 120 of nodes 104 through a plurality of container managers in accordance with a further embodiment of the present invention. It should be understood that the service manager 400 depicted in FIG. 4 may include additional features and that some of the features described herein may be removed and/or modified without departing from the scope of the service manager 400.

Generally speaking the service manager 400 may be equivalent to the service managers 130, 200, 300 depicted in FIGS. 1-3 in that the service manager 400 may execute the same or similar functions as the service managers 130, 200, 300. The description of service manager 400 is thus made with reference to the features depicted in FIG. 1. However, the service manager 400 may include differences or may execute different functions as discussed herein.

As shown, the service manager 400 may include a gateway 402 that may provide a gateway service through which tenant requests (e.g., calls) may be received into the service manager 400. The gateway 402 may handle verification of the authenticity of the tenants that submit the requests. The gateway 402 may also monitor a plurality of microservices 404 and may route received calls to the correct microservice 404. By way of particular example, a plurality of processors 202, 302 in one or more servers may host the microservices 404.

The microservices 404 may be defined as services that may be coupled to function as an application or as multiple applications. That is, for instance, an application may be split into multiple services (microservices 404) such that the microservices 404 may be executed separately from each other. By way of example, one microservice 404 of an application may be hosted by a first machine, another microservice 404 of the application may be hosted by a second machine, and so forth. The applications corresponding to the microservices 404 are discussed in greater detail herein.

According to examples, the microservices 404 may manage a plurality of tenant services in slices 406-1 to 406-K, in which the variable K represents a value greater than one. Particularly, the microservices 404 in a first slice 406-1 may manage tenant services of a first set of tenants, the microservices 404 in a second slice 406-2 may manage tenant services of a second set of tenants, and so forth. That is, for instance, the microservices 404 in a first slice 406-1 may manage deployment of tenant services for a first set of tenants, may manage changes to deployed tenant services for the first set of tenants, etc. In one regard, splitting the microservices 404 into slices 406-1 to 406-K may enable the rollout of new versions of a service to be implemented in a safe manner. For instance, a new version of a service may be rolled out to a first set of tenants prior to being rolled out to the other sets of tenants and if it is safe to do so, the new version may be rolled out to a second set of tenants, and so forth.

The microservices 404 may also be hosted in partitions 408-1 to 408-L, in which the variable L may represent a value greater than one. The microservices 404 may be partitioned such that different microservices 404 may support different tenant loads. Thus, for instance, if a limit for microservices 404 for a tenant is reached, another partition 408 may be added to support additional services for the tenant.

As also shown in FIG. 4, the service manager 400 may include an allocator 410 that may determine node allocations for tenant services from the pool of available nodes 104, e.g., nodes that span across multiple clusters 102. Particularly, for instance, the allocator 410 may take a plurality of parameters as input and may determine a node allocation for a request, e.g., to determine a node to execute a tenant service deployment request, that meets a predefined goal. For instance, the allocator 410 may determine a node allocation that results in a minimization of costs associated with executing the request, in a fulfillment of the request within a predefined time period, in a satisfaction of terms of a service level agreement, or the like. The parameters may include records of node inventories, such as records of node allocations.

According to examples, one of the applications of the service manager 400 that the microservices 404 may execute may be a tenant actor application. The microservices 404 of the tenant actor application may drive the goal state of a tenant. Thus, by way of example in which there are two virtual machines that are to be provisioned for a given tenant, the microservices 404 may provision the virtual machines by first communicating with the allocator 410 to obtain allocation information for the virtual machines. The microservices 404 may also communicate with the appropriate container manager 120 to instruct the container manager 120 to drive the allocated node 104 to the goal state (e.g., expected state). The microservices 404 may also update the statuses of the tenant goal state to an exhibit synchronization service, which may also be hosted as microservices 404. In one example, the microservices 404 that may execute the tenant actor application may execute write operations and the microservices 404 that may execute the exhibit synchronization service may execute read operations.

For instance, the microservices 404 that execute the exhibit synchronization service may monitor tenant service deployments to monitor the status of the tenant. The microservices 404 may also serve gate queries, read operations, e.g., querying about the status of a deployment, how many virtual machines exists for a given deployment, etc., after the microservices 404 that execute the tenant actor application drive the goal state of the tenant and updates the exhibit synchronization service. In addition, the microservices 404 that execute the exhibit synchronization service may be responsible for providing the tenant status at any given time.

The microservices 404 may also execute a tenant management service that, based on the type of the call, may redirect the call to either the microservices 404 that execute the tenant actor application or the exhibit synchronization service. For instance, the tenant management service may direct all of the write calls to the tenant actor application microservices 404 and all of the read calls to the exhibit synchronization service microservices 404. In one regard, splitting the calls in this manner may enhance scaling.

The microservices 404 may also execute a secret store service that may store secret information associated with the tenants, e.g., deployment secrets. The microservices 404 may further execute an image actor service that may update a tenant after a tenant service is deployed, updated, etc. The microservices 404 may still further execute a tenant management API service that may receive all of the calls associated with service management operations. The tenant management API service microservices 404 may redirect calls to the appropriate microservices 404 that are to act on the calls. By way of example in which a received call is a write call, the tenant management API service microservices 404 may send the write call to the tenant actor microservices 404 to try to get the write call to that state. As another example in which a received call is a read call, the tenant management API service microservices 404 may send the read call to the exhibit synchronization service microservices 404 to get data responsive to the read call.

The microservices 404 may still further execute a synthetic workload service that may function to validate that the microservices 404 are functional. For instance, the synthetic workload service microservices 404 may determine whether the microservices 404 are functioning properly in terms of tenant deployment, deletion, upgrades, etc. The synthetic workload service microservices 404 may output a report of the health of the microservices 404.

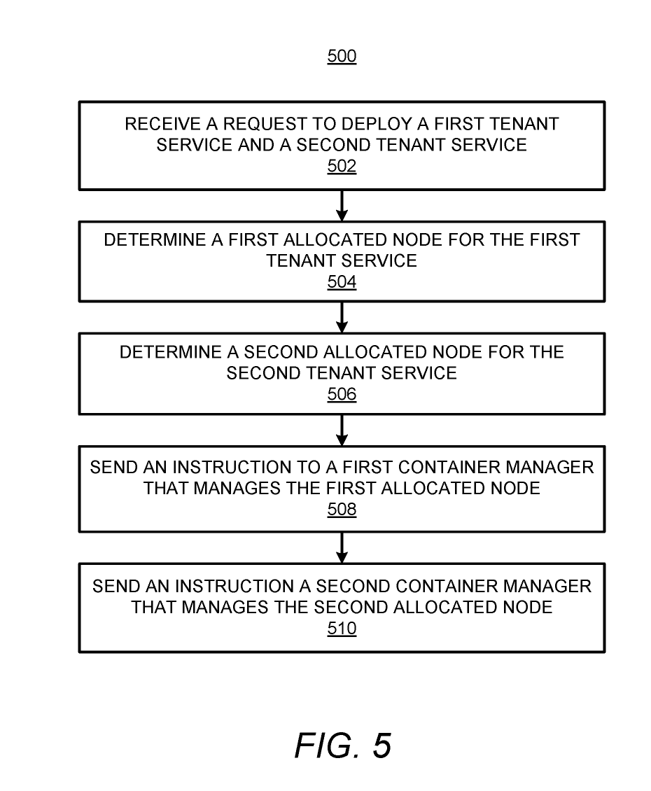

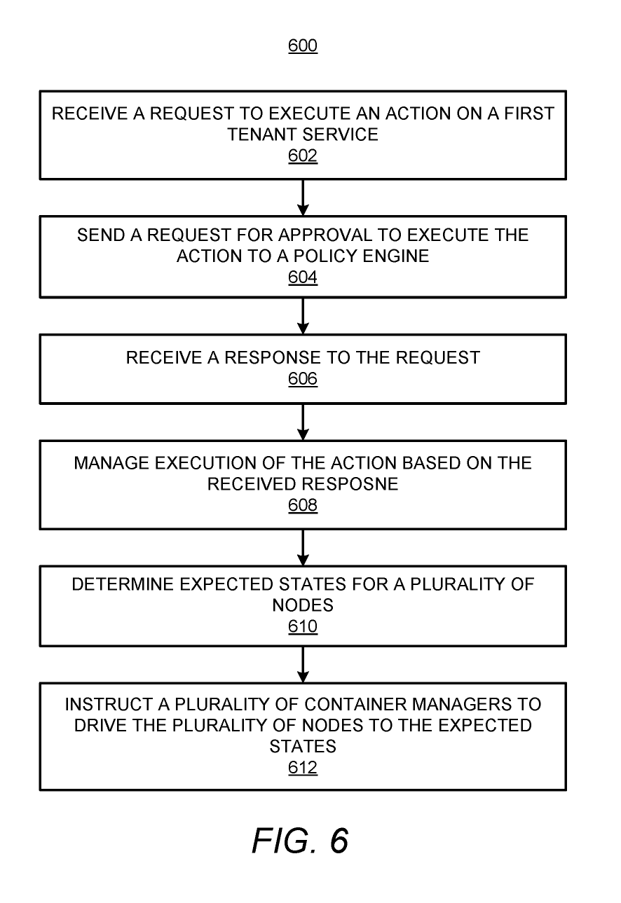

Various manners in which the processors 202, 302 of the service managers 130, 200, 300, 400 may operate are discussed in greater detail with respect to the methods 500 and 600 depicted in FIGS. 5 and 6. Particularly, FIGS. 5 and 6, respectively, depict flow diagrams of methods 500 and 600 for managing deployment of customer services across multiple clusters 102 of nodes 104 in accordance with embodiments of the present disclosure. It should be understood that the methods 500 and 600 depicted in FIGS. 5 and 6 may include additional operations and that some of the operations described therein may be removed and/or modified without departing from the scopes of the methods 500 and 600. The descriptions of the methods 500 and 600 are made with reference to the features depicted in FIGS. 1-4 for purposes of illustration.

With reference first to FIG. 5, at block 502, the processor 202, 302 may receive a request to deploy a first tenant service and a second tenant service. The first tenant service and the second tenant service may be tenant services of the same tenant. In addition, the first tenant service and the second tenant service may be in addition to previous tenant services that may have been deployed for the tenant.

At block 504, the processor 202, 302 may determine a first allocated node 106-1 for the first tenant service. In addition, at block 506, the processor 202, 302 may determine a second allocated node 108-1 for the second tenant service. For instance, the processor 202, 302 may determine the node allocations through execution of the allocator 410 depicted in FIG. 4, in which the nodes 106-1 and 108-1 may have been selected from a pool of nodes 104 that spans across multiple clusters 102 of nodes. Thus, for instance, the first allocated node 106-1 may be in a first cluster 102-1 and the second allocated node 108-1 may be in a second cluster 102-2. As discussed herein, a first container manager 120-1 may manage the first allocated node 106-1 and a second container manager 120-2 may manage the second allocated node 108-1.

At block 508, the processor 202, 302 may send an instruction to the first container manager 120-1 that manages the first allocated node 106-1 to drive the first allocated node 106-1 to deploy the first tenant service. In addition, at block 510, the processor 202, 302 may send an instruction to the second container manager 120-2 that manages the second allocated node 108-1 to drive the second allocated node 108-1 to deploy the second tenant service.

Turning now to FIG. 6, at block 602, the processor 202, 302 may receive a request to execute an action on the first tenant service. That is, for instance, the processor 202, 302 may receive a request to execute an action on a first tenant service that has been deployed to the first node 106-1. The requested action may include, for instance, taking down a service instance, rebooting a node, upgrading an operating system of a node, migrating a service instance, upgrading a service, upgrading a service instance, or the like.

At block 604, the processor 202, 302 may send a request for approval to execute the action to a policy engine 140. The policy engine 140 may determine whether the requested action may violate a policy and if so, the policy engine 140 may deny the request. However, if the policy engine 140 determines that the requested action does not violate a policy, the policy engine 140 may approve the request. In any regard, the policy engine 140 may send a response including the result of the determination back to the processor 202, 302. In addition, at block 606, the processor 202, 302 may receive the response to the request from the policy engine 140.

At block 608, the processor 202, 302 may manage execution of the action based on the received response. For instance, based on receipt of an approval to execute the action from the policy engine, the processor 202, 302 may instruct the appropriate container manager 120 to execute the action. However, based on receipt of a denial to execute the action from the policy engine, the processor 202, 302 may deny the request to execute the action.

At block 610, the processor 202, 302 may determine expected states for a plurality of nodes 104 that span across multiple clusters 120 of nodes. The expected states may be states for which the nodes 104 are to be responsive to requests or calls received by the processor 202, 302. For instance, the processor 202, 302 may receive write calls and/or read calls and the processor 202, 302 (or equivalently, the microservices 404) may determine the expected states for the nodes 104 based on the received calls.

At block 612, the processor 202, 302 may instruct a plurality of container managers 120 that manage the plurality of nodes 104 to drive the nodes 104 to the expected states. In this regard, a service manager 130, 200, 300, 400 may determine the expected states while multiple container managers 120 may drive the nodes in different clusters 120 to the expected states.

Some or all of the operations set forth in the methods 500 and 600 may be included as utilities, programs, or subprograms, in any desired computer accessible medium. In addition, the methods 500 and 600 may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A system comprising:
a plurality of clusters of nodes;
a plurality of container manager hardware processors, wherein each of the container manager hardware processors is to manage the nodes in a respective cluster of nodes; and
at least one service manager hardware processor to manage deployment of customer services across multiple clusters of the plurality of clusters of nodes through the plurality of container manager hardware processors.

2. The system of claim 1, wherein each of the plurality of container manager hardware processors manages an inventory of the nodes in the respective cluster of nodes.

3. The system of claim 1, wherein the service manager hardware processor is further to:
receive requests regarding the customer services;
determine expected states for a plurality of the nodes based on the received requests; and
instruct at least one container manager hardware processor that manages the plurality of nodes to drive the plurality of nodes to the expected states.

4. The system of claim 3, wherein the service manager hardware processor is separate from the plurality of container manager hardware processors and wherein the plurality of nodes span across multiple clusters of the plurality of clusters.

5. The system of claim 4, wherein at least two container manager hardware processors are to drive the plurality of nodes in separate clusters to the expected states based on receipt of the instruction from the service manager hardware processor.

6. The system of claim 1, wherein the service manager hardware processor is to determine an action to be taken on a customer service, the system further comprising:
a policy engine, wherein the service manager hardware processor is to send a request for approval of the determined action to the policy engine and wherein the policy engine is to determine whether to allow the determined action.

7. The system of claim 1, wherein the at least one service manager hardware processor is further to separately handle write requests and read requests.

8. The system of claim 1, wherein the at least service manager hardware processor hosts a plurality of microservices and wherein the plurality of microservices manages the deployment of customer services in slices and partitions.

9. A service manager comprising:
at least one processor;
at least one memory on which is stored machine readable instructions that are to cause the at least one processor to:
receive a request to deploy a tenant service;
determine an allocated node for the tenant service from a pool of nodes that spans across multiple clusters of nodes, wherein a separate container manager manages the nodes in a respective cluster of nodes; and
send an instruction to the container manager that manages the allocated node to drive the allocated node to host the tenant service.

10. The service manager of claim 9, wherein the machine readable instructions are further to cause the at least one processor to:
receive a second request to deploy a second tenant service;
determine a second allocated node for the second tenant service from the pool of nodes, the second allocated node being in a different cluster of nodes than the allocated node; and
send an instruction to a second container manager that manages the second allocated node to drive the second allocated node to host the second tenant service.

11. The service manager of claim 9, wherein the machine readable instructions are further to cause the at least one processor to:
receive a request to execute an action on the tenant service;
send a request for approval to execute the action to a policy engine;
based on receipt of an approval to execute the action from the policy engine, instruct the container manager to execute the action; and
based on receipt of a denial to execute the action from the policy, deny the request to execute the action.

12. The service manager of claim 9, wherein the machine readable instructions are further to cause the at least one processor to:
receive requests regarding a plurality of tenant services;
determine expected states for a plurality of nodes based on the received requests, wherein the plurality of nodes span across multiple clusters of nodes; and
instruct a plurality of container managers that manage the plurality of nodes to drive the plurality of nodes to the expected states.

13. The service manager of claim 9, wherein the machine readable instructions are further to cause the at least one processor to:
separately handle write requests and read requests.

14. The service manager of claim 9, wherein the machine readable instructions are further to cause the at least one processor to:
host a plurality of microservices and wherein the plurality of microservices manages a plurality of tenant services in slices.

15. The service manager of claim 9, wherein the machine readable instructions are further to cause the at least one processor to:
host a plurality of microservices and wherein the plurality of microservices manages a plurality of tenant services in partitions.

16. A method comprising:
receiving, by at least one processor, a request to deploy a first tenant service and a second tenant service;
determining, by the at least one processor, a first allocated node for the first tenant service and a second allocated node for the second tenant service from a pool of nodes that spans across multiple clusters of nodes, wherein a separate container manager manages the nodes in a respective cluster of nodes;
sending, by the at least one processor, an instruction to a first container manager that manages the first allocated node to drive the first allocated node to deploy the first tenant service; and
sending, by the at least one processor, an instruction to a second container manager that manages the second allocated node to drive the second allocated node to deploy the second tenant service.

17. The method of claim 16, further comprising:
receiving a request to execute an action on the first tenant service;
sending a request for approval to execute the action to a policy engine;
based on receipt of an approval to execute the action from the policy engine, instructing the container manager to execute the action.

18. The method of claim 17, further comprising:
based on receipt of a denial to execute the action from the policy engine, denying the request to execute the action.

19. The method of claim 16, further comprising:
determining expected states for a plurality of nodes, wherein the plurality of nodes span across multiple clusters of nodes; and
instructing a plurality of container managers that manage the plurality of nodes to drive the plurality of nodes to the expected states.

20. The method of claim 16, further comprising:
hosting a plurality of microservices that manages a plurality of tenant services in slices of tenant services and in partitions of tenant services.
